(19) United States
(12) Patent Application Publication
(10) Pub. No.: US 2016/0183039 A1
(43) Pub. Date: Jun. 23, 2016

(54) METHOD AND SYSTEM FOR COMPONENT MANAGEMENT

(71) Applicant: GE AVIATION SYSTEMS LLC, Grand Rapids, MI (US)

(72) Inventor: Frazer Leslie PEREIRA, Gloucester (GB)

(21) Appl. No.: 14/968,397

(22) Filed: Dec. 14, 2015

(30) Foreign Application Priority Data
Dec. 23, 2014 (GB) 1423051.0

(51) Int. Cl. H04W 4/00

(52) U.S. Cl. CPC H04W 4/008

(57) ABSTRACT

A component management system including a component, a near field communication chip (NFC chip) provided on the component and having a memory in which is stored a component data file containing at least a component identifier, and a near field enabled mobile device configured to communicate with the NFC chip using near field communication.

### BACKGROUND OF THE INVENTION

Contemporary aircraft include systems and components that are routinely examined by ground technicians for status, upkeep, maintenance and repair purposes. This information is traditionally noted into a handbook or a personal digital assistant (PDA) and is either available to the manufacturer at a later stage or is not available at all.

BRIEF DESCRIPTION OF THE INVENTION

In one embodiment, the invention relates to a component management system including a component, a near field communication chip (NFC chip) provided on the component and having a memory in which is stored a component data file containing at least a component identifier, a near field enabled mobile device configured to communicate with the NFC chip using near field communication and having an component management application wherein when the mobile device is brought close enough to the component to establish communication with the NFC chip, the component management application may read/write data to the component data file.

In another embodiment, the invention relates to a method of managing a plurality of components having a NFC chip with an NFC-enabled mobile device having a management application, comprising running the management application when the mobile device is brought within proximity of the component to establish near field communication with the NFC chip, uploading to the management application at least a portion of a component data file residing in a memory of the NFC chip, receiving an input to the management application indicative of a management action for the component, and downloading from the management application to the component data file action data related to the management action.

### BRIEF DESCRIPTION OF THE DRAWINGS

In the drawings:

FIG. 1 is a schematic illustration of a component management system according to one embodiment of the invention.

FIG. 2 is a flow chart showing a method of managing a plurality of components according to an embodiment of the invention.

### DESCRIPTION OF EMBODIMENTS OF THE INVENTION

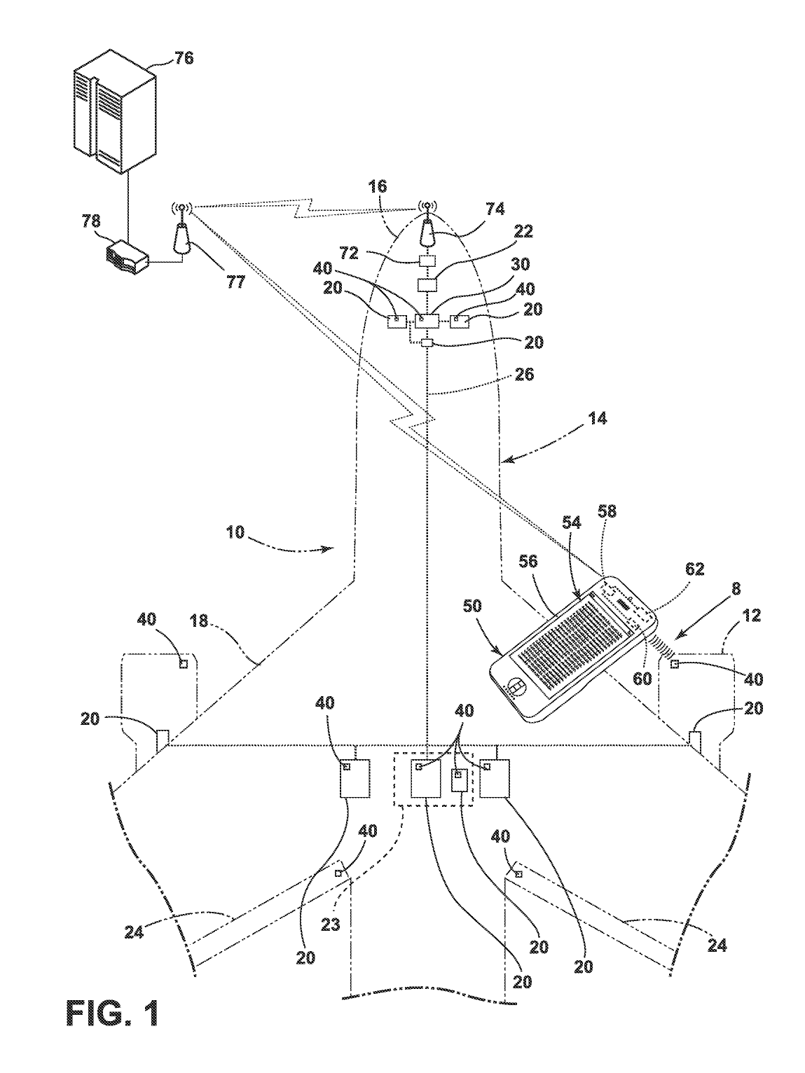

FIG. 1 schematically illustrates a component management system 8 according to embodiments of the invention. The component management system 8 is illustrated as being utilized with components of an aircraft 10. While components on a commercial aircraft have been illustrated, it is contemplated that embodiments of the invention may be used with any type of components including non-vehicle components. Further, embodiments of the invention can be utilized with both mechanical structures as well as all other equipment. The environment of the aircraft 10 will be described for explanatory purposes only.

One or more propulsion engines 12 may be coupled to a fuselage 14, a cockpit 16 may be positioned in the fuselage 14, and wing assemblies 18 may extend outward from the fuselage 14. A plurality of aircraft systems and components 20 that enable proper operation of the aircraft 10 may be included as well as a flight control computer or computer 22. The plurality of aircraft systems and components 20 may reside within the cockpit 16, within the electronics and equipment bay 23, or in other locations throughout the aircraft 10 including that they may be associated with the engines 12 and the wing assemblies 18. Such aircraft systems and components 20 may include but are not limited to: an electrical system, an oxygen system, hydraulics and/or pneumatics system, a fuel system, a propulsion system, navigation systems, flight controls, audio/video systems, an Integrated Vehicle Health Management (IVHM) system, and systems and components associated with the mechanical structure of the aircraft 10 including flaps 24. A variety of aircraft systems and components 20 have been illustrated for exemplary purposes and it will be understood that they are only a few of the systems and components that may be included in the aircraft 10. A data network 26 over which the plurality of aircraft systems and components 20 may communicate with each other and provide information to a crew of the aircraft 10 may be included. For example, the aircraft systems and components 20 may output various information to a flight deck 30 located in a cockpit 16 of the aircraft 10.

The component management system 8 may be utilized with any of the above-described components, including systems having multiple components. For ease of explanation, the remainder of the application will focus on a component in the form of one of the propulsion engines 12. A near field communication chip (NFC chip) 40 may be provided on each of the components including on each one of the propulsion engines 12. The NFC chip 40 may also be commonly referred to as a NFC tag. The NFC chip 40 may include a memory in which is stored a component data file containing at least a component identifier such as a serial number for the propulsion engine 12. It will be understood that any suitable data may be included in the component data file including a manufacturing date, prior maintenance information, damage information including a rating on a scale regarding the amount of damage, additional sections relevant to the particular part, etc. It is contemplated that the NFC chip 40 may be operably coupled to any suitable portion of the component in any suitable manner. For components, which involve harsh environments such as the propulsion engine 12, the NFC chip 40 may be embedded in the component itself. The NFC chip 40 requires minimal power. By way of non-limiting examples, the NFC chip 40 may be operably coupled to the component itself to receive power or may be operably coupled with batteries. By way of further non-limiting example, the NFC chip 40 may utilize power from NFC devices that are reading it. In such an instance the NFC device that is reading the chip may actively generate an RF field that can power the NFC chip 40.

A near field enabled mobile device 50 may be included in the component management system 8 and may be configured to communicate with the NFC chip 40 using near field communication. The near field enabled mobile device 50 may be operated by a user (not shown) such that the near field enabled mobile device 50 may be capable of interfacing with the NFC chip 40 of the component 12. In this manner, the near field enabled mobile device 50 may be considered to have a near-field communication interface 58.

A display 54 may be included in the near field enabled mobile device 50. It is contemplated that the display 54 may be a touch screen 56, although this need not be the case, such that the user 52 may interact with the display 54 through the touch screen 56. While the near field enabled mobile device 50 has been illustrated as a phone having a touch screen 56 it will be understood that the handheld device may be a scanner, PDA, tablet PC, or any other suitable type of mobile device. A keyboard or cursor control may also be provided in the near field enabled mobile device 50 to allow for user interaction with the display 54.

In order to be capable of wirelessly linking with other systems and devices, the near field enabled mobile device 50 may also include any suitable wireless communication link 60, which may include, but is not limited to, packet radio, satellite uplink, Wireless Fidelity (WiFi), WiMax, AeroMACS, Bluetooth, ZigBee, 3G wireless signal, code division multiple access (CDMA) wireless signal, global system for mobile communication (GSM), 4G wireless signal, long term evolution (LTE) signal, Ethernet, or any combinations thereof. It will also be understood that the particular type or mode of wireless communication is not critical to embodiments of this invention, and later-developed wireless networks are certainly contemplated as within the scope of embodiments of this invention.

A controller 62 may be included in the near field enabled mobile device 50 and may be operably coupled to components of the near field enabled mobile device 50 including the display 54, touch screen 56, near-field communication interface 58, and wireless communication link 60. The controller 62 may include any suitable memory and processing units, which may be running any suitable programs to implement a graphical user interface (GUI) and operating system.

The near field enabled mobile device 50 may include a computer program or component management application having an executable instruction set for exchanging information when the near field enabled mobile device 50 is placed within close proximity of the NFC chip 40. The component management application may include an applications, software program, computer program product, etc. that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc. that have the technical effect of performing particular tasks or implement particular abstract data types. Machine-executable instructions, associated data structures, and programs represent examples of program code for executing the exchange of information as disclosed herein. Machine-executable instructions may include, for example, instructions and data, which cause a general-purpose computer, special-purpose computer, or special-purpose processing machine to perform a certain function or group of functions.

The component management application may allow a user to access or read the data file of the NFC chip 40 as well as update or write to the data file. The component management application may include a damage scale, which may include options selectable by a user to convey the amount of damage the component has incurred. The near field enabled mobile device 50 may also be configured to couple to a remote processing center and the component management application may automatically provide information thereto. The mobile device further couples to a manufacturer's database to provide information on the mobile device related to manufacturing information, repair information, or inventory information.

In this manner it will be understood that the component management system 8 may also include a computer 76, other than the near field enabled mobile device 50 and that is remote from the near field enabled mobile device 50 and may be in wireless communication with the near field enabled mobile device 50 and/or the aircraft 10. It is contemplated that the computer 76 may be remote from the near field enabled mobile device 50 and the aircraft 10. For example, the computer 76 may be located at airline central maintenance, airline control, remote processing center, a manufacturer's database location, etc. The computer 76 may include any suitable wireless communication link 77 capable of wirelessly linking with other systems and devices. The computer 76 may be directly coupled with the wireless communication link 77 or may be indirectly coupled to the wireless communication link 77 through a secondary communication link 78, which may include an internet connection to couple the computer 76 to the wireless communication link 77. The computer 76 may also communicate with a wireless link 74 of the aircraft 10 to communicate therewith.

It is contemplated that the wireless communication link 60 of the near field enabled mobile device 50 may include a secure wireless communication system that may be in communication with a secure wireless communication system of the computer 76 to establish a secure communication. In this manner, the near field enabled mobile device 50 may securely wirelessly communicate with other systems such as airline central maintenance or airline control, a remote processing center, and/or a manufacturer's database. The secure communication between the computer 76 and the near field enabled mobile device 50 may be performed after one of the computer 76 and the near field enabled mobile device 50 recognizes the other of the computer 76 and the near field enabled mobile device 50 to provide for a secure communication.

During operation, when the near field enabled mobile device 50 is brought close enough to the component to establish communication with the NFC chip 40, the component management application may communicate with the NFC chip 40 such that it may read/write data to the component data file within the NFC chip 40. The near field enabled mobile device 50 may require close proximity to the NFC chip 40. It is contemplated that the close proximity may be less than 25 cm. By way of a further example, the close proximity may be between 4 cm and 20 cm. Such a close proximity makes the NFC chip 40 more secure because it is difficult for unauthorized personnel to be that near an aircraft.

In this manner, data related to a particular component may be included on the NFC chip 40 and the NFC chip 40 may be operably coupled to the component itself. When personnel inspect the component, the NFC chip 40 interacts with the near field enabled mobile device 50 and may open an application where the personnel may conveniently update information relevant to the component.

It is contemplated that once information is transferred to the near field enabled mobile device 50 that such information may be securely communicated to the computer 76. The near field enabled mobile device 50 may execute a program for transmitting data from the near field enabled mobile device 50 to the computer 76. It is contemplated that such a process may be user initiated or may be implemented automatically by the near field enabled mobile device 50. This may allow the information to be transferred to the computer 76.

It will be understood that details of environments that may implement embodiments of the invention are set forth in order to provide a thorough understanding of the technology described herein. It will be evident to one skilled in the art, however, that the exemplary embodiments may be practiced without these specific details and in alternative manners. The exemplary embodiments are described with reference to the drawings. These drawings illustrate certain details of specific embodiments that implement a module or method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

As noted above, embodiments described herein may include a computer program product comprising machine-readable media for carrying or having machine-executable instructions or data structures stored thereon. Such machine-readable media may be any available media, which may be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that may be used to carry or store desired program code in the form of machine-executable instructions or data structures and that may be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general-purpose computer, special purpose computer, or special purpose processing machines to perform a certain function or group of functions.

Embodiments will be described in the general context of method steps that may be implemented in one embodiment by a program product including machine-executable instructions, such as program codes, for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

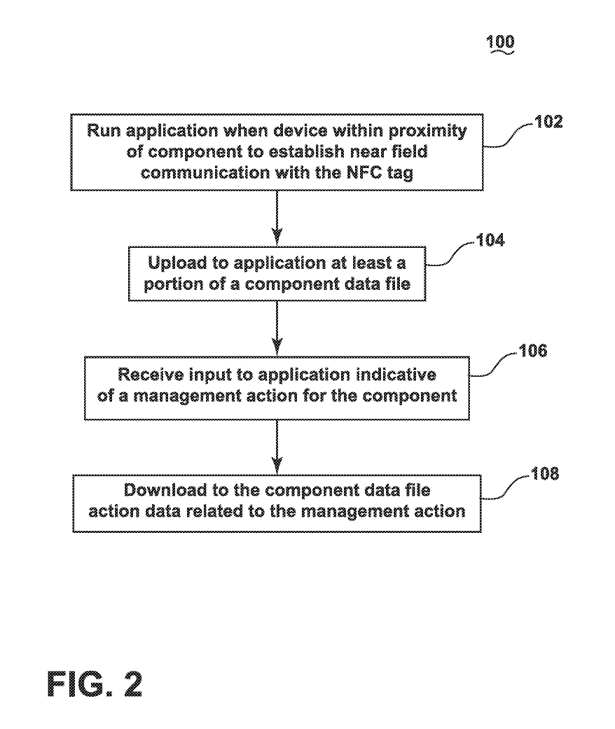

In accordance with an embodiment of the invention, FIG. 2 illustrates a method 100, which may be used for managing a plurality of components, each having a NFC chip 40, with an NFC-enabled mobile device 50 having a management application. The method may begin at 102 by running the management application when the near field enabled mobile device 50 is brought within proximity of the component to establish near field communication with the NFC chip 40. It is contemplated that the running of the management application may be either manual or automatic as it may be selected by a user or may automatically start when the NFC chip 40 is sensed. At 104, information, such as, at least a portion of a component data file residing in a memory of the NFC chip 40 may be uploaded to the management application. In this manner, the near field enabled mobile device 50 may read at least a portion of the component data file. For example, the component identifier may be read by the near field enabled mobile device 50.

At 106, an input to the management application indicative of a management action for the component may be received. The maintenance action may pertain to both maintenance data and inventory data. For example, the input may relate to maintenance data, damage information, etc. At 108, action data related to the management action may be downloaded from the management application of the near field enabled mobile device 50 to the component data file in the NFC chip 40. Thus, information may be written to the component data file of the NFC chip 40. In this manner, personnel may provide the NFC chip of the component with information related to the component, any damage of the component, maintenance performed, maintenance scheduled to be performed, etc.

By way of non-limiting example, this may include that routine maintenance and/or inspection was determined to be needed based on the component data file at 104. Based on the inspection, a maintenance action was conducted by the personnel and entered into the application at 106. The taking of the maintenance action is then written to the NFC chip 40 at 108 so such information stays with the component.

It will be understood that the method 100 of managing a plurality of components is flexible and the method 100 illustrated is merely for illustrative purposes. For example, the sequence of steps depicted is for illustrative purposes only, and is not meant to limit the method 100 in any way, as it is understood that the steps may proceed in a different logical order or additional or intervening steps may be included without detracting from embodiments of the invention. By way of non-limiting example, the method may also include automatically coupling to a remote processing center and the component management application may automatically provide information thereto. Further, the method may also include automatically coupling to a manufacturer's database to provide information on the mobile device related to manufacturing information, repair information, or inventory information. In this manner, information may be made available to the OEM of the product, appropriate maintenance services can be conducted on time, and components may be adequately stocked.

The embodiments described above provide a variety of benefits including that they provide a means to for personnel to interact with a component and a handheld device using near-field communications. The technical effect provided is that when personnel inspect the component, the chip and mobile device may interact such that the personnel may conveniently update information relevant to the component and such information may stay with the component. The above embodiments do not require high infrastructure and installation costs. Stickers and barcodes suffer from constant wear and information can be easily fabricated with such methods.

The above-described embodiments may be particularly useful in mechanical systems that rely on visual diagnostics, i.e. human inspection, for inspection. Manual asset-tracking systems are very time consuming and prone to human failure in reading and/or copying serial and part numbers. The above-described embodiments allow for more efficient collection of part information and as the information may be automatically provided to other systems may aid in improving stocking strategies for components.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A component management system comprising:
a component;
a near field communication chip (NFC chip) provided on the component and having a memory in which is stored a component data file containing at least a component identifier; and
a near field enabled mobile device configured to communicate with the NFC chip using near field communication and having a component management application; and
wherein when the mobile device is brought close enough to the component to establish communication with the NFC chip, the component management application may read/write data to the component data file.

2. The component management system of claim 1 wherein the NFC chip is embedded in the component.

3. The component management system of claim 1 wherein the component management application further comprises a damage scale selectable by a user.

4. The component management system of claim 3 wherein the mobile device further couples to a remote processing center and the component management application automatically provides information thereto.

5. The component management system of claim 1 wherein data in the data file further comprises at least one manufacturing date or prior maintenance information.

6. The component management system of claim 1 wherein the mobile device further couples to a manufacturer's database to provide information on the mobile device related to manufacturing information, repair information, or inventory information.

7. A method of managing a plurality of components having a NFC chip with an NFC-enabled mobile device having a management application, comprising:
running the management application when the mobile device is brought within proximity of a component to establish near field communication with the NFC chip;
uploading to the management application at least a portion of a component data file residing in a memory of the NFC chip;
receiving an input to the management application indicative of a management action for the component; and
downloading from the management application to the component data file action data related to the management action.

8. The method of claim 7 wherein the management action comprises maintenance data.

9. The method of claim 7 wherein the management action comprises damage information.

10. The method of claim 7 wherein a component identifier is uploaded.
